(19) United States
(12) Patent Application Publication
(10) Pub. No.: US 2008/0055951 A1
(43) Pub. Date: Mar. 6, 2008

(54) Power converter circuit and method for feeding a system from a DC voltage source

(75) Inventor: Dejan Schreiber, Nurnberg (DE)

Correspondence Address: COHEN, PONTANI, LIEBERMAN & PAVANE, 551 FIFTH AVENUE, SUITE 1210, NEW YORK, NY, 10176, US

(73) Assignee: SEMIKRON Elektronik GmbH & Co. KG

(21) Appl. No.: 11/894,324

(22) Filed: Aug. 21, 2007

(30) Foreign Application Priority Data
Aug. 25, 2006 (DE) 10 2006 039 974.9

(51) Int. Cl. H02M 7/5387

(52) U.S. Cl. 363/132

(57) ABSTRACT

Circuit and method for converting a DC voltage, which is not constant over time and is preferably from a solar energy installation, into an AC voltage. The circuit arrangement has an input inductor and an H-bridge having a respective first current valve and a respective second current valve, preferably an RB-IGBT, for each branch, each current valve having a switchable forward direction and a reverse direction. A capacitor is additionally connected between the two branches of the AC voltage connection of the H-bridge. During operation, the RB-IGBTs of the H-bridge operate in a cyclical pulsed mode and are occasionally used as step-up converters together with the input inductor.

### BACKGROUND OF THE INVENTION

1. Field of the Invention

This invention is directed to the field of power converters for converting a DC voltage, which is not constant over time, to an AC voltage, and, more particularly, to such power converters having a small number of components.

2. Description of the Related Art

There are many applications that involve receiving a peak voltage of, for example, 230 V from a DC voltage source which is not constant over time and fluctuates, for example, between 25 V and 200 V, and converting that DC voltage to AC. Such applications include solar energy installations, for example. In such applications, the power and voltage emitted by the solar energy installation depend on the irradiated light intensity and the connection and number of photocells. The DC voltage must therefore be fed into an AC voltage system through a converter circuit.

The prior art in this field includes, for example, converter circuits having a step-up converter, an intermediate circuit having a buffer capacitor, and a bridge circuit, generally an H-bridge circuit having an inductor and a capacitor in the AC voltage connections.

The disadvantage of such prior art converter circuits is that they require a multiplicity of components and so cannot be produced in a cost-effective manner.

There is therefore an object of the invention to provide a power converter circuit that is simpler and cheaper to manufacture than those found in the prior art.

### SUMMARY OF THE INVENTION

It is an object of the invention to provide a power converter circuit that addresses the deficiencies of the prior art.

The invention is directed to a converter circuit and an associated method for converting a DC voltage, which is not constant over time, into an AC voltage, wherein the converter circuit has a small number of components and can therefore be produced in a cost-effective manner, and also allows a DC voltage having a voltage value that is less than the peak value of the AC voltage to be fed in.

The inventive circuit converts a DC voltage, which is not constant, into an AC voltage. The AC voltage preferably has a peak value which is greater than the maximum value of the DC voltage value. The circuit has an input inductor which is connected to the DC voltage source and a downstream H-bridge, as well as a capacitor between the two AC voltage outputs of the H-bridge.

Each branch of the H-bridge has a first current valve and a second current valve. Each current valve is switchable between a forward direction and a reverse direction. It is particularly advantageous if the current valve is in the form of a reverse blocking insulated gate bipolar transistor (RB-IGBT).

The inventive method for converting a DC voltage, which is not constant, into an AC voltage using such a circuit, is characterized in that the current valves of the H-bridge operate in a cyclical pulsed mode and are used as step-up converters in conjunction with the input inductor.

The inventive concept is explained in more detail using the exemplary embodiments in FIGS. 1 to 5.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a circuit arrangement according to the prior art;

FIG. 2 shows a first embodiment of a power converter circuit in accordance with the invention;

FIG. 3 shows a second embodiment of the inventive circuit;

FIG. 4 shows simulation results of a first embodiment of the inventive method; and

FIG. 5 shows simulation results of a second embodiment of the inventive method.

### DETAILED DESCRIPTION OF THE PRESENTLY PREFERRED EMBODIMENTS

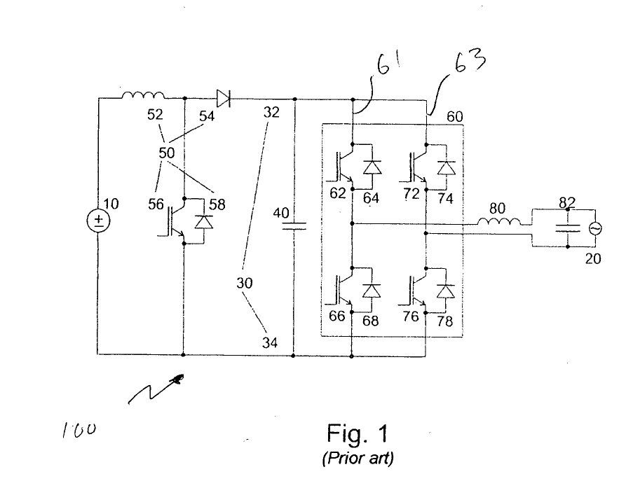

FIG. 1 shows, by way of example, a prior art power converter circuit 100. Circuit 100 converts a DC voltage 10 at its input into an AC voltage 20 at its output. When used for example, in a solar energy installation, input DC voltage 10 typically varies over time.

In order to increase input voltage 10, which has a large voltage range (for example from 40 V to 200 V for a system having a feed voltage of 230 V), to a constant value for an intermediate circuit 30, circuit 100 has a known step-up converter 50 that includes a switch, a transistor 56 with a diode 58 which is reverse-connected in parallel for short-circuiting the input DC voltage of circuit 100, as well as an input inductor 52 and a downstream diode 54. As a result of this, a DC voltage having a voltage value which is above the peak value of the AC voltage to be fed is produced in intermediate circuit 30.

Downstream of step-up converter 50, prior art circuit 100 has, as an energy store for intermediate circuit 30, a capacitor 40 between the two DC voltage branches 32, 34 which now have a quasi-constant potential. An H-bridge circuit 60 comprising a first current valve and a second current valve 63 for each branch is connected downstream of capacitor 40. Current valves 61, 63 are in the form of a respective bipolar transistor 62, 66, 72, 76, advantageously an IGBT (insulated gate bipolar transistor) with a diode 64, 68, 74, 78 which is reverse-connected in parallel.

An output inductor 80 is connected in one branch of the AC voltage output of H-bridge 60 and a capacitor 82 which is connected between the two branches in circuit-compliant fashion to AC voltage system 20 to be fed.

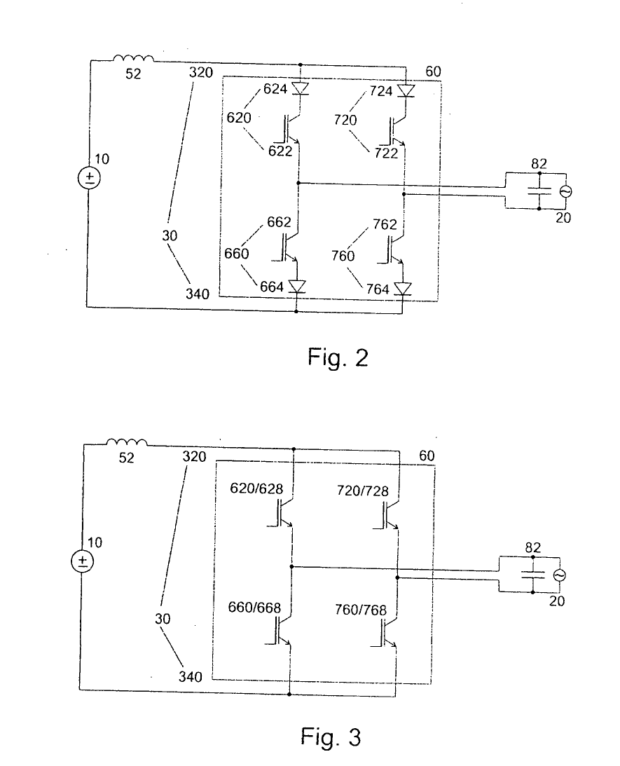

FIG. 2 shows a first embodiment of an inventive circuit arrangement. In this case, an input inductor 52 is arranged in a DC voltage branch 320, illustratively with a positive polarity. An H-bridge circuit 60 having a respective first current valve 620, 720 and a respective second current valve 660, 760 for each branch is connected downstream of this input inductor 52. These current valves have a switchable forward direction and a reverse direction and are each in the form of a serial arrangement of a diode 624, 664, 724, 764 and a transistor 622, 662, 722, 762, preferably an IGBT.

A capacitor 82 which is connected to AC voltage system 20 is connected between the two branches of the AC voltage output of H-bridge 60.

FIG. 3 shows a second embodiment of the inventive circuit, in which, in comparison with that shown in FIG. 2, IGBTs 622, 662, 722, 767 have been replaced with RB-IGBTs (reverse blocking insulated gate bipolar transistor) 628, 668, 728, 768 and diodes 624, 664, 724, 764 (FIG. 2) can thus be dispensed with. In comparison with the prior art, the number of components required is thus reduced to an even more significant extent than shown in FIG. 2, which allows, on the one hand, more efficient operation and, on the other hand, less expensive production.

The inventive method for converting a DC voltage, which is not constant, into an AC voltage having a peak value above the maximum value of the DC voltage value uses input inductor 52, together with current valves 620, 660, 720, 760 of H-bridge 60, as a step-up converter.

To this end, the method cyclically repeats a first partial cycle and a subsequent second partial cycle. The first partial cycle is characterized by the following sequence:
Both current valves 620, 660 in a first branch of H-bridge 60 are in the “on” state and a current flows through the input inductor 52, the associated current intensity being increased as a result of the short circuit.
First current valve 620 in the first branch and second current valve 760 in the second branch are in the “on” state for a suitable period of time and the current through input inductor 52 continues to flow counter to the AC voltage of the system to be fed, the current intensity being further reduced.
In order to uniformly load all of the current valves, both current valves 720, 760 in the second branch of H-bridge 60 are in the “on” state, the current through the input inductor 52 continues to flow and its current intensity is increased again. Alternatively, current valves 620, 660 in the first branch of H-bridge 60 may also be in the “on” state.
The first current valve 620 in the first branch and second current valve 760 in the second branch are in the “on” state and the current through the input inductor 52 continues to flow counter to the AC voltage of the system to be fed, its current intensity being further reduced.

The temporal relationship of this cyclical sequence within this first partial cycle is selected in such a manner that the first half-cycle of the sinusoidal output current is approximated using pulse width modulation. Output capacitor 82 smoothes the generated AC voltage. The second partial cycle is characterized by the following sequence, the current through input inductor 52 being retained in this case as well:

Both current valves 720, 760 in a second branch of the H-bridge 60 are in the “on” state.

First current valve 720 in the second branch and the second current valve 660 in the first branch are in the on state.

Both current valves 620, 660 in a first branch of H-bridge 60 are in the “on” state. Alternatively, the two current valves 720, 760 in the second branch are in the “on” state.

First current valve 720 in the second branch and second current valve 660 in the first branch are in the “on” state.

This second partial cycle produces a second half-cycle with a polarity opposite that of the first half-cycle.

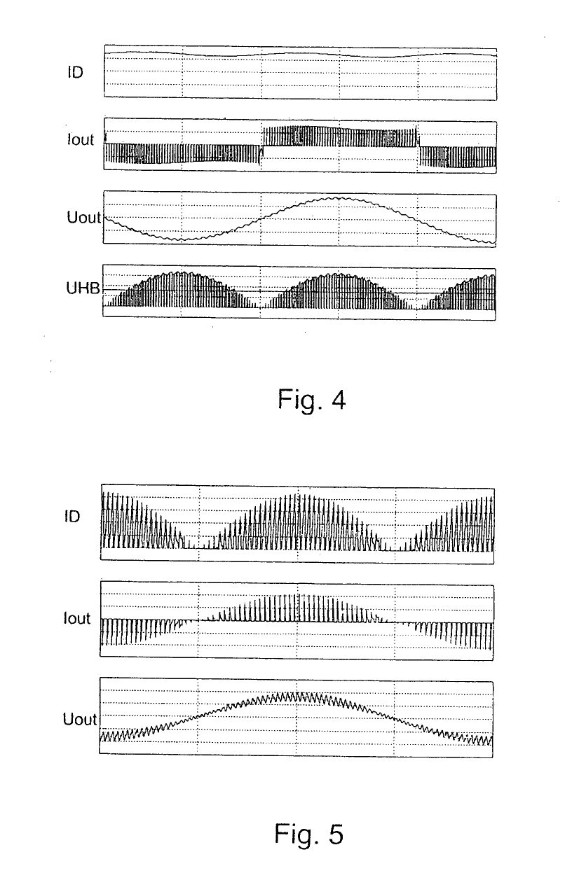

FIG. 4 shows an embodiment of the inventive method with an input inductor 52 of a first inductance, the latter being selected to be considerably larger than that in the further embodiment described below. In this embodiment, the inductance is selected in such a manner that the current (ID) through input inductor 52 is substantially constant within a half-cycle of the output voltage during the pulsed mode and does not fall to zero.

Since current (ID) is generally constant, the current rises slightly during a short-circuit phase of the current valves in a branch of H-bridge 60 and falls slightly again during the feed phase while diagonally arranged current valves of H-bridge 60 are in the “on” state. A sinusoidal oscillation at twice the frequency of the system voltage is superimposed on this profile.

As a result of pulse width modulation of the driving of H-bridge 60, the envelope of the voltage (UHB) between positive connection 320 and negative connection 360 of H-bridge 60 thus has a sinusoidal profile, the voltage (UHB) itself falling to zero during the short-circuit phases.

The sum of the intervals of time with short-circuit phases within a half-period of the output voltage is determined by the ratio of the input voltage to the mean value of the output voltage.

The output current (Iout) with an approximately constant amplitude forms a pulse pattern having a duty cycle which, averaged over time, has a generally sinusoidal profile.

This embodiment of the inventive method uniformly loads DC voltage source 10 since the energy is stored in input inductor 52 and discharged again during a half-period. Current is fed into the system to be fed at the output in a pulsating manner, the first harmonic (fundamental) of the current (Iout) and the voltage (Uout) being in phase.

FIG. 5 shows simulation results of a further embodiment of the inventive method. In this case, the inductance of input inductor 52 is considerably smaller than in the embodiment described above. In this embodiment, due to the relatively small inductance of input inductor 52, the current (ID) through input inductor 52 occasionally falls to zero during pulse width modulation.

In the suitably selected interval of time of the respective short circuit of the two current valves in a branch of H-bridge 60, the current (ID) across input inductor 52 increases. In those intervals of time in which diagonally arranged current valves of H-bridge 60 are in the “on” state, the current (ID) falls to zero. In this case, the pulse width modulation is controlled in such a manner that the envelope of the current profile (ID) through input inductor 52 is sinusoidal.

The current (Iout) likewise has a pulsed profile with a sinusoidal envelope at the output of H-bridge 60. The voltage (Uout) across capacitor 82 at the output likewise exhibits a sinusoidal profile and is in phase with the envelope of the current profile (Iout).

The currently required energy is thus taken from DC voltage source 10, is stored in input inductor 52 and is then fed into system 20 in the respective interval of time of the half-period. This produces a sinusoidal profile of the envelope of the feed current (Iout).

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A circuit for converting a DC voltage, which is not constant over time, into an AC voltage, the circuit comprising:
an input inductor; and
an H-bridge having a respective first current valve and a respective second current valve for each branch, each of said first and second current valves having a switchable forward direction and a reverse direction, and also having a capacitor which is connected between the two branches of the AC voltage connection of said H-bridge.

2. The circuit of claim 1, wherein each of said first and second current valves is a reverse blocking insulated gate bipolar transistor (RB-IGBT).

3. The circuit of claim 1, wherein each of said first and second current valves comprises a serial arrangement of a diode and a transistor.

4. A method for converting a DC voltage, which is not constant, into an AC voltage using a circuit arrangement comprising:
an input inductor; and
an H-bridge having a respective first current valve and a respective second current valve for each branch, each of said first and second current valves having a switchable forward direction and a reverse direction, having a capacitor which is connected between the two branches of the AC voltage connection of said H-bridge, and also being operational as a step-up converter,
the method comprising the step of operating the current valves of said H-bridge in a cyclical pulsed mode in conjunction with the input inductor.

5. The method of claim 4, wherein
a first cycle of the method comprises the following partial cycles;
both current valves in a first branch of the H-bridge are in the “on” state;
the first current valve in the first branch and the second current valve in the second branch are in the “on” state;
both current valves in a second branch of the H-bridge are in the “on” state; and
the first current valve in the first branch and the second current valve in the second branch are in the “on” state; and
a second cycle comprises the following partial cycles
both current valves in a second branch of the H-bridge are in the “on” state;
the first current valve in the second branch and the second current valve in the first branch are in the “on” state;
both current valves in a first branch of the H-bridge are in the “on” state; and
the first current valve in the second branch and the second current valve in the first branch are in the “on” state.

6. The method of claim 4, wherein the current flowing continuously through the input inductor and the output voltage (Uout) and the first harmonic of the output current (Iout) are in phase during operation.

7. The method of claim 4, wherein the envelope of current (ID) through the input inductor has a sinusoidal profile and the envelope of the output current (Iout) is in phase with the output voltage (Uout) during operation.
